(19) United States
(12) Patent Application Publication
(10) Pub. No.: US 2026/0240624 A1
(43) Pub. Date: Aug. 20, 2026

(54) FABRICATED QUIJADA

(71) Applicant: Julio Llerena, West Miami, FL (US)

(72) Inventor: Julio Llerena, West Miami, FL (US)

(21) Appl. No.: 19/540,644

(22) Filed: Feb. 14, 2026

Related U.S. Application Data
(60) Provisional application No. 63/758,490, filed on Feb. 14, 2025.

(51) Int. Cl. A61C 7/00; H04R 1/28

(52) U.S. Cl. CPC A61C 7/00; H04R 1/288

(57) ABSTRACT

A fabricated quijada has two opposing frames. Each frame includes a proximal handle, a distal batter panel, and a central region for housing a resonance box. The resonance box houses a plurality of longitudinally aligned teeth and has a top surface with a plurality of transverse ridges. The handles of the opposing frames are connected by a trapezoidal link such that the frames taper away from each other along a longitudinal axis. An operator holds the fabricated quijada by the handles and generates a rattle sound by striking the batter panel. A ratchet sound may be generated by running a stick across the transverse ridges on the top of the resonance box.

### CROSS-REFERENCE TO RELATED APPLICATIONS

This application claims priority to U.S. Provisional Application Ser. No. 63/758,490 filed on Feb. 14, 2025, the contents of which are incorporated in their entirety.

### STATEMENT REGARDING FEDERALLY SPONSORED RESEARCH OR DEVELOPMENT

Not Applicable.

### NAMES OF PARTIES TO A JOINT RESEARCH AGREEMENT

Not Applicable

### REFERENCE TO SEQUENCE LISTING, A TABLE, OR A COMPUTER PROGRAM LISTING APPENDIX SUBMITTED ON A COMPACT DISC AND INCORPORATION-BY-REFERENCE OF THE MATERIAL

Not Applicable.

### COPYRIGHT NOTICE

Not Applicable

### BACKGROUND OF THE INVENTION

### Field of the Invention

The present invention relates to a fabricated percussion instrument that combines features of a rattle and a guiro. More particularly, the invention relates to a quijada formed from wood or other synthetic materials instead of bone.

### Description of the Related Art

The quijada, also known as a charrasca or jawbone, is an Latin American or African idiophone instrument made from the jawbone of a donkey. It can also be made from the jawbones of other animals, such as a horse, mule, and the like. To create a quijada, the jawbone of a donkey must be cleaned of tissue and dried to make the teeth loose and act as a rattle. Historically, this is done by leaving the jawbone in an arid region, or on an anthill. Once the jawbone is adequately cleaned and dried, the teeth remain in place, but become loose within their sockets.

To play a quijada, a musician holds the jawbone by the front, proximal end, and strikes the ramus of one side of the jawbone, usually with his or her palm heel or thumb pad. This causes the teeth to rattle. A quijada may also be played like a guiro by running a wooden, or other, rod along the top of the teeth to create a ratchet sound.

Because the quijada is made from an animal's jawbone, they are not easily mass-produced. To create a new one, a person must wait for a donkey to die. Cleaning and drying out the jawbone is also time-consuming and not necessarily pleasant. More recently, there has been greater interest in ethnic music such as that made using the quijada. However, since the quijada is made from the parts of an animal, it can be difficult to transport across international borders. Finally, the teeth in a quijada may become too loose and fall out of the jawbone, reducing the quality of the instrument.

While there are many rattle type percussion instruments, as well as many ratchet type percussion instruments, there is a dearth of instruments that adequately perform both functions. Many attempts have been made to create a synthetic, or fabricated, musical instrument that adequately mimics a quijada. There are a variety of guiros that have been modified to incorporate maracas into the instrument. These devices all provide sounds that differ substantially from that of a quijada. More recently, an instrument known as the “vibraslap” was invented as an alternative to a quijada, but it has no rattling functionality. Furthermore, all these instruments are shaped differently than a classic quijada. A musician familiar with a quijada cannot easily transfer to one of these alternative instruments because they are operated in substantially different ways. There have been attempts at making a fabricated quijada out of wood. However, these too have failed to generate a sound similar to that of a classic quijada.

The above-described deficiencies of today's systems are merely intended to provide an overview of some of the problems of conventional systems, and are not intended to be exhaustive. Other problems with the state of the art and corresponding benefits of some of the various non-limiting embodiments may become further apparent upon review of the following detailed description.

In view of the foregoing, it is desirable to provide a fabricated quijada that is operated in the same manner as and generates a sound comparable to a classic quijada formed from a donkey jawbone.

### BRIEF SUMMARY OF THE INVENTION

Disclosed is a fabricated quijada that accurately replicates the sound, appearance and functionality of a traditional bone quijada.

In one embodiment, a fabricated quijada comprises two opposing frames. Each frame has an elongate handle at a proximal end, a batter panel at its distal end, and a resonance box between the proximal and distal ends. A link connects the handles of the opposing frames such that they are oriented at about a 5°-25° angle relative to each other. The resonance box includes a plurality of teeth linearly aligned along a longitudinal direction, and the teeth are sized and configured to rattle when the batter panel is impinged upon. The fabricated quijada also includes a plurality of transverse exterior ridges that may be struck to generate a ratchet sounds. The fabricated quijada may optionally include a resonance box with enclosed resonance chamber, which may optionally have one or more sound holes providing fluid communication with the enclosed resonance chamber.

The fabricated quijada may optionally include teeth that protrude from an opening in the resonance box, and transverse ridges are located on the top of the teeth.

It is therefore an object of the present invention to provide a fabricated quijada that accurately replicates the sounds and functionality of a bone quijada, but is made from wood, plastic, or other non-bone materials.

These and other objects and advantages of the present invention will become apparent from a reading of the attached specification and appended claims. There has thus been outlined, rather broadly, the more important features of the invention in order that the detailed description thereof that follows may be better understood, and in order that the present contribution to the art may be better appreciated. There are features of the invention that will be described hereinafter and which will form the subject matter of the claims appended hereto.

### BRIEF DESCRIPTION OF THE DRAWINGS

A more complete understanding of the present invention, and the attendant advantages and features thereof, will be more readily understood by reference to the following detailed description when considered in conjunction with the accompanying drawings wherein:

FIG. 1 is a perspective view of a fabricated quijada in accordance with principles of the invention;

FIG. 2 is another perspective view of a fabricated quijada in accordance with principles of the invention;

FIG. 3 is a cross-sectional view of a fabricated quijada in accordance with principles of the invention;

FIG. 4 is a perspective view of a resonance chamber of a fabricated quijada in accordance with principles of the invention;

FIG. 5 is a side elevation view of a frame for a fabricated quijada in accordance with principles of the invention;

FIG. 6 is a perspective view of an alternative embodiment of a fabricated quijada in accordance with principles of the invention;

FIG. 7 is an exploded view of an alternative embodiment of a fabricated quijada in accordance with the principles of the invention.

### DETAILED DESCRIPTION

The invention is not limited in its application to the details of construction and to the arrangements of the components set forth in the following description or illustrated in the drawings. The invention is capable of other embodiments and of being practiced and carried out in various ways. Also, it is to be understood that the phraseology and terminology employed herein are for the purpose of description and should not be regarded as limiting.

The disclosed subject matter is described with reference to the drawings, wherein like reference numerals are used to refer to like elements throughout. In the following description, for purposes of explanation, numerous specific details are set forth in order to provide a thorough understanding of the various embodiments of the subject disclosure. It may be evident, however, that the disclosed subject matter may be practiced without these specific details. In other instances, well-known structures and devices are shown in block diagram form in order to facilitate describing the various embodiments herein. Various embodiments of the disclosure could also include permutations of the various elements recited in the claims as if each dependent claim was a multiple dependent claim incorporating the limitations of each of the preceding dependent claims as well as the independent claims. Such permutations are expressly within the scope of this disclosure.

Unless otherwise indicated, all numbers expressing quantities of ingredients, dimensions, reaction conditions and so forth used in the specification and claims are to be understood as being modified in all instances by the term “about”. The term “a” or “an” as used herein means “at least one” unless specified otherwise. In this specification and the claims, the use of the singular includes the plural unless specifically stated otherwise. In addition, use of “or” means “and/or” unless stated otherwise. Moreover, the use of the term “including”, as well as other forms, such as “includes” and “included”, is not limiting. Also, terms such as “element” or “component” encompass both elements and components comprising one unit and elements and components that comprise more than one unit unless specifically stated otherwise.

Various embodiments of the disclosure could also include permutations of the various elements recited in the claims as if each dependent claim was a multiple dependent claim incorporating the limitations of each of the preceding dependent claims as well as the independent claims. That is, the combinations of the various components of the invention are not limited to those combinations expressly shown in the Figures. Unless expressly stated otherwise, components described in one embodiment may be interchanged with components of the same name found in other embodiments. Such permutations are expressly within the scope of this disclosure.

Disclosed is a fabricated quijada formed from wood and stone. The fabricated quijada has approximately the same shape as a jawbone quijada, having a handle at its proximal end corresponding to the front of a jawbone, batter panels at its distal end corresponding to the ramus'of a jawbone, and resonance boxes between the handle and batter panels for mimicking both the rattling and ratcheting sounds of a classic quijada. The resonance boxes include a parallelepipedal internal resonance chamber housing a plurality of parallelepipedal fabricated teeth. The internal volume of the resonance chamber is larger than the total volume of the fabricated teeth. Thus, the teeth may move within the resonance chamber to generate a rattling sound. Unlike common rattling musical instruments such as the maraca, the fabricated teeth within the resonance chamber remain linearly aligned such that their movement is restricted. The top of the residence chamber includes a plurality of ridges that may be struck to generate a guiro sound.

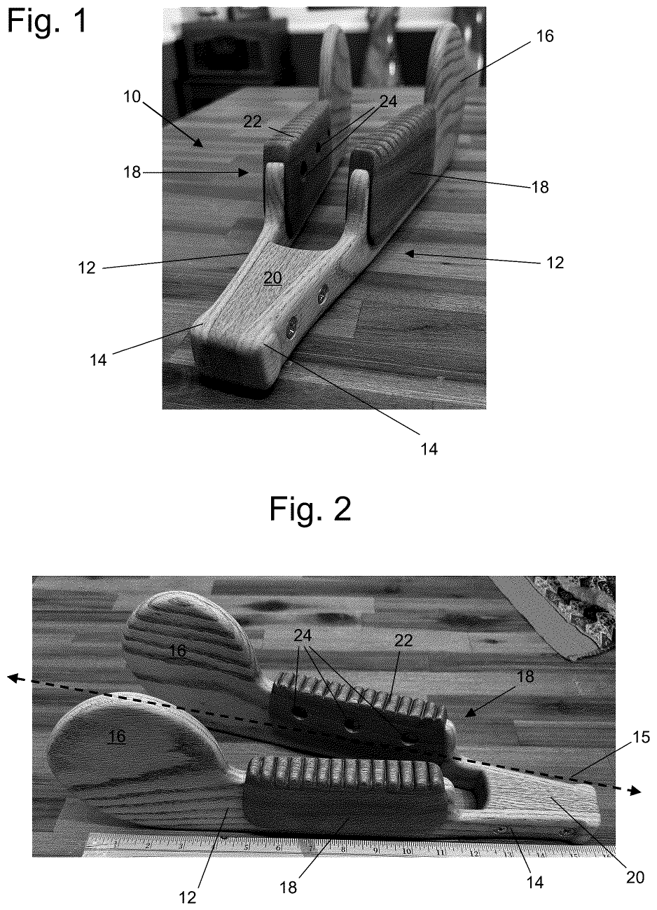

FIGS. 1 and 2 show a fabricated quijada 10 in accordance with principles of the invention. The quijada 10 includes two opposing frames 12, each having a proximal handle 14, a distal batter panel 16, and a resonance box 18. The proximal handles 14 are connected by a frame link 20 having a substantially trapezoidal shape such that the opposing frames 12 taper away from each other along a longitudinal axis 15 from the handles 14 to the panel 16. The handles 14 and link 20 are attached in this embodiment using counter sunk wood screws. Those skilled in the art will appreciate that there are a wide variety of fasteners suitable for assembling the fabricated quijada 10. The resonance boxes 18 include a plurality of transverse ridges 22 and one or more sound holes 24 along their internal sides 26. The ridges 22 are transverse to the longitudinal axis 15.

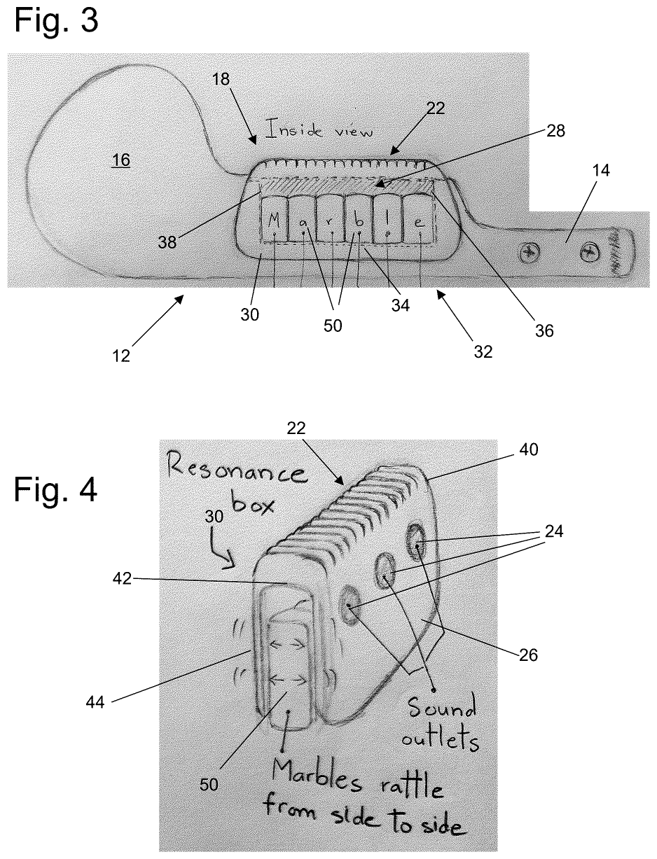

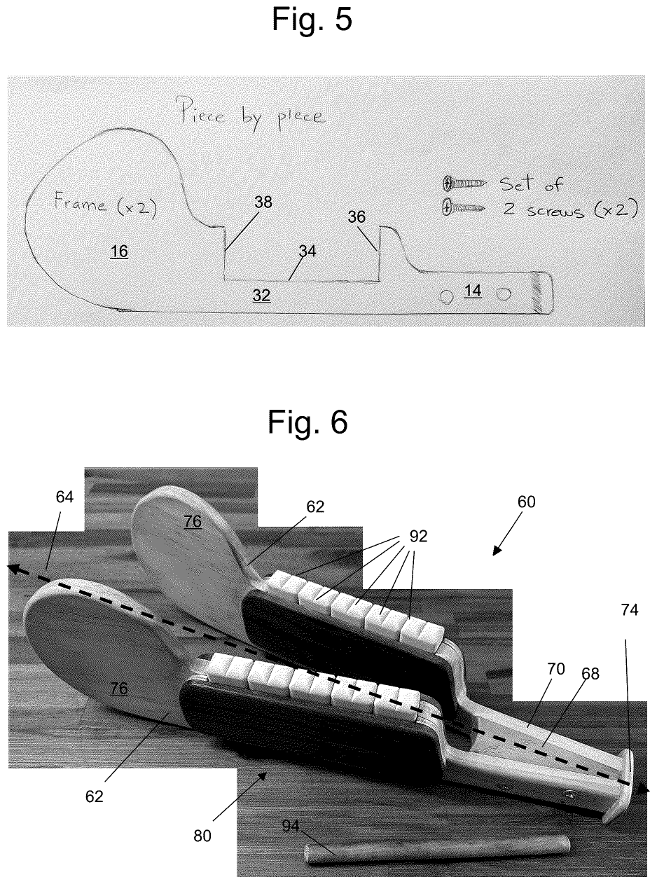

FIGS. 3 to 5 show the internal components of the fabricated quijada 10, including resonance chamber 28 within the resonance box 18. Each resonance box 18 is formed by an upper casing 30 attached to the central region 32 of the frame 12. The central region 32 is positioned between the handle 14 and batter panel 16. The central region 32 of the frame forms a resonance chamber base 34, a front chamber wall 36 and rear chamber wall 38. The casing 30 has a top 40 which defines the upper wall 42 of the resonance chamber 28, and has external transverse ridges 22. The casing 30 also includes an external side 44, and an internal side 26. When the upper casing 30 is affixed to the central region 32 of the frame 12, it forms the internal resonance chamber 28.

As explained above, in this embodiment the sound holes 24 are located on the internal side 26 of the resonant box's upper casing 30. However, the sound holes 24 may be located anywhere on the resonance box 18 so long as they provide fluid communication with the resonance chamber 28 with the outside. Exemplary sound holes 24 are circular and longitudinally aligned. However, those skilled in the art will appreciate that the sound holes may come in a wide variety of shapes, sizes, number and location.

A plurality of rattling fabricated teeth 50 are linearly aligned along the longitudinal axis 15 inside the resonance chamber 28. The teeth 50 are configured such that they may not fall out of alignment. In this embodiment, each of the teeth 50 are almost as wide as the transverse width of the chamber 28. The total combined volume of the teeth 50 is less than the total volume of the resonance chamber 28. In this embodiment, the teeth 50 are all substantially shorter than the height of the chamber 28, which is defined by the distance between the base 34 and the upper wall 42. This allows the teeth to move up and down relatively freely within the chamber but only relatively minor movement is allowed in the longitudinal direction and from side to side. The teeth in this embodiment are also substantially rectangular in shape such that they lie flush against each other and besides and bottom of the chamber. This configuration allows the teeth to rattle and vibrate within the chamber and a limited and specific manner. Without being bound by theory, the inventor believes this configuration allows the fabricated quijada 10 to effectively mimic the unique rattle percussion of a bone quijada. To more closely reproduce unique quijada rattling sound, the teeth 50 are preferably formed from marble and are configured to have flat sides that lies substantially flush between the teeth 50.

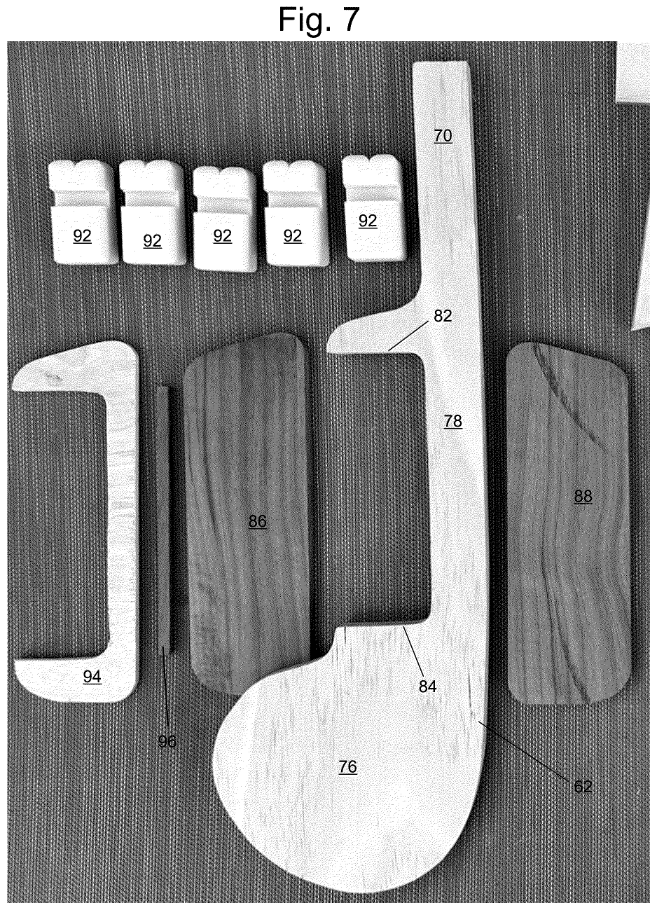

FIGS. 6 and 7 show an alternative embodiment of a fabricated quijada 60 in accordance with principles of the invention. The primary difference between the fabricated quijada 60 and the quijada 10 disclosed in FIGS. 1 to 6 is that the alternative embodiment quijada 60 does not include a fully enclosed resonance chamber. Fabricated quijada 60 includes two opposing frames 62 that taper away from each other along a longitudinal axis 64 due to the trapezoidal shape of the link 68 which connects the proximal handles 70 of the frames 62. An optional frontpiece 74 extends over the link 68 and handles 70 at the proximal end of the quijada 60. The frames 62 also include batter panels 76 and a central region 78. As with the fabricated quijada 10, the central region 78 of the quijada 60 has a resonance box 80.

The resonance box's 80 structure is best understood by referring to FIG. 7 in addition to FIG. 6. The central region 78 of the frames 62 form the front wall 82 and a rear wall 84 of the resonance box 90. An external side wall 86 and internal side wall 88, which are congruent, are attached to each side of the frame to form a resonance box 90 with an open top. Teeth 92 extend upward out of the box. A stick 94 may be slid across the tops of the exposed teeth to generate a ratchet sound. When the batter panels 76 are struck, the teeth 92 vibrate in the resonance box 90 to generate a rattle sound. The exposed teeth more closely replicate the appearance of a bone quijada.

FIG. 7 shows the components of the fabricated quijada 60. An extension plate 94 is aligned with the flush with the front and rear walls 82 and 84, respectively, of the frame 62, and is sandwiched between the one of the side walls and the frame 62 to increase the transverse width of the resonance box. A retaining bar 96 is affixed to either the external side wall 86 or internal side wall 88 inside the resonance box 90 and is complimentary to the slots 98 in the teeth 92. The retaining bar 96 extends through the slots 98 and prevents the teeth 92 from falling out of the resonance box 90. Teeth 92, like the teeth 50, are linearly arranged along the longitudinal axis 64. The teeth 50 have flat sides that lie approximately flush against each other and to the sides of the resonance box 80. This restrains the movement of the teeth 92, so that the rattle sound of a bone quijada is better imitated, and also restrains the transverse ridges on the tops of the teeth from rotating away from an orientation transverse to the longitudinal axis 64. The retaining bar 96 also prevents rotation of the teeth 92, so that optionally, the teeth 92 may have a cylindrical or other configuration.

The extension plate 94 allows the frame to be thinner than the width of the resonance chamber. By accommodating a thinner frame, the quijada 60 is more flexible, and therefore more accurately mimics the sounds of a bone quijada. The width of the frame will depend on the desired auditory parameters of the quijada and the type of material used in its fabrication. In the embodiment shown in FIG. 6, the extension plate 94 is positioned between the external side wall 86 and the frame 62. Optionally, the extension plate 94 may be positioned between the internal side wall 88 and the frame. Optionally, the central region 78 of the frame 62 may be wider than the rest of the frame.

Whereas, the present invention has been described in relation to the drawings attached hereto, other and further modifications, apart from those shown or suggested herein, may be made within the spirit and scope of this invention. Those skilled in the art will appreciate that the conception, upon which this disclosure is based, may readily be utilized as a basis for the designing of other structures, methods and systems for carrying out the several purposes of the present invention. Descriptions of the embodiments shown in the drawings should not be construed as limiting or defining the ordinary and plain meanings of the terms of the claims unless such is explicitly indicated. The claims should be regarded as including such equivalent constructions insofar as they do not depart from the spirit and scope of the present invention.

1. A fabricated quijada comprising:
two opposing frames, each having an elongate handle at a proximal end, a batter panel at its distal end, and a resonance box between the proximal and distal ends; and,
a frame link connecting the handles of the opposing frames such that they are oriented at about a 30°-5° angle relative to each other;
wherein the resonance box includes a plurality of teeth linearly aligned along a longitudinal direction, and the teeth are sized and configured to rattle when the batter panel is impinged upon.

2. The fabricated quijada of claim 1 wherein each of the resonance boxes includes a plurality of exterior ridges transverse to the longitudinal direction.

3. The fabricated quijada of claim 2 wherein the resonance box includes an enclosed resonance chamber.

4. The fabricated quijada of claim 3 wherein each of the resonance boxes includes one or more sound holes providing fluid communication with the enclosed resonance chamber.

5. The fabricated quijada of claim 2 wherein the teeth protrude from an opening in the resonance box and the transverse ridges are located on the teeth.
